(19) United States
(12) Patent Application Publication
(10) Pub. No.: US 2003/0104205 A1
(43) Pub. Date: Jun. 5, 2003

(54) Moisture barrier and energy absorbing cushion

(76) Inventors: Edouard A. Brodeur JR., Marietta, GA (US); Robert F. Weber, Acworth, GA (US)

Correspondence Address: CONLEY, ROSE & TAYON, P.C., 5700 GRANITE PARKWAY,, SUITE 330, PLANO, TX, 75024-6616, US

(21) Appl. No.: 10/306,271

(22) Filed: Nov. 27, 2002

Related U.S. Application Data
(60) Provisional application No. 60/335,294, filed on Nov. 30, 2001.

(51) Int. Cl. B32B 3/00; B32B 1/04; B32B 3/02; B32B 3/26; B32B 5/18; B32B 5/24; D02G 3/00

(52) U.S. Cl. 428/374; 428/314.4; 428/71; 428/76; 442/370

(57) ABSTRACT

A fabric reinforced closed cell foam composite having a textured or smooth surface which is substantially free of nodular surface irregularities. The fabric may be formed of woven fibers or of non-woven random fibers which are bonded together by resin or heat. The fabric is then coated to a suitable thickness with a foamed or unfoamed polymer formulation. The cushion has a high strength to weight ratio, is substantially impermeable to liquids, significantly dampens sound and absorbs energy. In addition, the cushion is non-slip, remaining substantially fixed in relation to the surface to which it is in contact by means of friction. Further, the surface of the cushion is relatively easily decorated with printed designs. Dyes could also be added to the foam formulation to produce a wide range of decorative colored cushions.

### CROSS-REFERENCE TO RELATED APPLICATIONS

This application claims priority to U.S. Provisional Patent Application No. 60/335,294 entitled “Moisture Barrier and Sound and Energy Absorption Cushion” filed on Nov. 30, 2001.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention relates to a cushion for flooring system underlayments, for shelf, drawer, bath and shower liners, for place mats and table cloths, for furniture surface coverings and other applications requiring a cushion. More particularly, the cushion is a fabric reinforced closed cell foam composite that functions as a moisture barrier, a sound deadening and an energy absorption layer.

### BACKGROUND OF THE INVENTION

Underlayments used in flooring systems are positioned between a subfloor and a decorative floor treatment such as tile, wood, carpet, rug and the like. These underlayments can be useful as vapor barriers to protect the decorative floor from moisture, to dampen sounds and absorb energy created by foot contact and other traffic on the decorative floor and to provide a degree of cushioning to the decorative floor treatment. Additionally, some types of underlayments will minimize the difficulties associated with the installation and wear of decorative floor treatments which are installed over subfloors having surface irregularities.

Flooring system underlayments can be laminated products or separate layers of materials. For example, a thin continuous film of plastic, such as polyethylene or vinyl, can be installed over the subfloor to provide a vapor barrier. A polymeric open cell foam layer can be positioned over the plastic film beneath the decorative floor treatment to add a degree of cushioning. The plastic film and open cell foam layer can be components of a laminated product or can be separate layers installed one layer over the other. Alternatively, a solid sheet of plastic having some cushioning characteristics, for example, a slightly plasticized vinyl chloride polymer, can function as both a vapor barrier and a cushion between the subfloor and the decorative floor treatment. Another suitable floor underlayment is a laminate composite of a moisture impervious vinyl, polyethylene, or polyester film which is adhered to a latex or vinyl foam.

Underlayments are particularly suitable for use with solid wood or laminate decorative floor treatments. For example, decorative floor treatments having tongue and groove joints can be placed over the underlayment and secured together with adhesive applied to the joints. However, proper application of the adhesive is cumbersome and time consuming, as excess adhesive can leak onto the decorative flooring treatment, and must be removed. A suitable dry adhesive could be pre-applied to the tongue and groove joints by the manufacturer of the decorative floor treatment. The dry adhesive would form a bond between the joints of the decorative floor upon contact. Adhesive can also be applied to the underlayment proximate the joint of the decorative floor treatment for bonding the decorative floor treatment to the underlayment.

Underlayments are also applicable for use with decorative floor treatments having mechanical bonding capabilities. These decorative floor treatments traditionally have contoured male and female edges which form a mechanical joint as their edges are mated and clicked together. The mechanical joint provides strength for holding the edges together so long as the surfaces of the decorative floor treatments are maintained relatively parallel to the subfloor. Thus, while a cushion underlayment is desirable, the cushioning effect is preferably relatively minimal for click type joint decorative floor treatments to preclude misalignment of the parallel configuration of the decorative floor treatments.

Shelf and drawer liners, place mats, table cloths, and furniture surface coverings are useful to protect household products such as dishes, glasses, cups, cooking and bake ware and home accessories which are traditionally placed on kitchen shelves, in drawers and on furniture, from scuffs, chips, breaks and wear. The products also protect the shelf, drawers and furniture surfaces from wear. In addition, the products deaden sound and absorb energy which is emitted when the household products come into contact with the surfaces of the shelves, drawers and furniture. Useful products can also function as a moisture barrier between the surfaces and the household products which may be wet or damp after washing. In some cases, liners, mats, table cloths and furniture surface coverings which have decorative features are suitable for enhancing the aesthetics of the surfaces on which they are placed. The decorative features help to coordinate with the surrounding colors and designs in the room.

Traditional shelf and drawer liners, place mats, table cloths and furniture surface coverings include thin contact paper formed of vinyl, polyester, polyethylene and paper films. Some of these products have a backing of adhesive for long term affixation to the surface to be covered, such as, for example, a shelf. However, contact liners are often too flimsy for some applications and possesses little sound or energy dampening characteristics.

Another product suitable for liners, including bath, shower, shelf and drawer liners, and for place mats, table cloths and furniture surface coverings, is a woven polyester fabric, often resembling lace, which is coated with vinyl foam to form an open mesh material, the openings having various shapes and sizes. These open mesh foam coated products are difficult to clean and do not protect the underlying surface from contaminants. Of course, the open mesh product can be laminated to a thin moisture impervious film such as vinyl or polyester. However, this composite is expensive and difficult to manufacture, as the foam cells are easily crushable during lamination, resulting in dimensional instability.

In yet another approach, a film of vinyl or polyester affixed to a layer of rubber or polymer foam is a suitable product for liners, place mats, table cloths and furniture surface coverings. These products require multiple manufacturing steps which are generally processed off line rather than on a continuous line operation. In addition, dimensional stability problems are common, as the product does not comprise a stabilizing or reinforcing material, such as fabric.

Accordingly, there is a need for a foam composite that may be produced in sheets and is suitable for use as a floor underlayment. It would also be desirable to have a material that may be suitable for other household applications such as shelf liners, drawer liners and the like. A foam composite should have energy absorbing properties, sound deadening characteristics, water resistance and be relatively easy to clean. To be cost effective, this polymeric material should also be manufactured in a straightforward manner with a minimum of processing steps. Consequently, one preferred embodiment of a foam composite may be produced without subsequent gluing or lamination steps for bonding separate layers of various materials.

### SUMMARY OF THE INVENTION

The reinforced foam composite of the present invention comprises a closed cell foam sheet and a completely embedded fabric having open interstices between fibers. The embedded fabric may be formed of woven fibers or of non-woven random fibers which are bonded together by resin or heat. The fabric is then coated to a suitable thickness with a foamed or unfoamed polymer formulation. The polymer formulation may comprise vinyl chloride, urethane or other suitable resins and may also contain various foaming agents. In one embodiment the polymer formulation may comprise a latex containing fluid filled mircospheres to facilitate foaming.

The cushion has a high strength to weight ratio, is substantially impermeable to liquids, significantly dampens sound and absorbs energy. Unlike open celled foams, the closed cell foam of the composite provides a substantially water proof barrier without additional polymer films or moisture barrier layers. In addition, the cushion is non-slip, remaining substantially fixed in relation to the surface to which it is in contact by means of friction. Further, the surface of the cushion is relatively easily decorated with printed designs. Dyes and colorants could also be added to the foam formulation to produce a wide range of decorative colored cushions.

A method of manufacturing a reinforced foam composite in accordance with the present invention is also disclosed. In one preferred embodiment, this may be carried out in a continuous manufacturing process having only three fundamental steps. First, a suitable fabric having open interstices between fibers is selected. Second, the upper and lower surfaces are coated in a polymeric resin composition capable of producing a closed cell foam. Third, resin coated fabric is heated to expand and cure the foam resin composition. In one embodiment, the fabric may be stretched on a tenter and the curing of the composite may be carried out by circulating heated air at about 300 to about 1000 feet per second across the upper and lower surfaces of the coated fabric. This allows the foam composite to expand vertically in an unconstrained manner which is believed to produce a finer cell structure in the foam. In another embodiment, the coating resin may be of latex, a rubber and water emulsion, which contains fluid filled microspheres. After heating to remove most of the water in the latex, the resin may be further heated to burst the mircospheres (to facilitate foaming) and to cure the rubber.

### DETAILED DESCRIPTION

The present invention provides a fabric reinforced closed cell foam composite having a textured or smooth surface which is substantially free of nodular surface irregularities. The cushion has a high strength to weight ratio, is substantially impermeable to liquids, significantly dampens sound and absorbs energy. In addition, the cushion is non-slip, remaining substantially fixed in relation to the surface to which it is in contact by means of friction. Further, the surface of the cushion is relatively easily decorated with printed designs. Dyes could also be added to the foam formulation to produce a wide range of decorative colored cushions. Wet, dry or pressure sensitive adhesives could be applied to the underside of the cushion for securing the cushion to the surface to be covered. In certain applications, the adhesive could also be applied to the upper side of the cushion for affixation under a surface such as, for example, a decorative floor treatment.

The cushion of the present invention comprises a fabric reinforced closed cell foam composite. The fabric may be formed of closely knitted or woven fibers. Alternatively, the fabric may be formed of non-woven random fibers which are spun bonded during manufacturing or subsequently bonded together by resin or heat. In one preferred embodiment, the fibers will form a fabric having open interstices which are less than about 10 millimeters, although other sizes may be suitable for the present invention.

The fibers can be of polyester, glass or other suitable materials. By way of example only, one type of suitable fiber material includes tricot knit polyester of 75 denier/36 filament and a weight per unit area of 1.65 ounces per square yard. In addition, the fibers of the fabric should be selected to have a high enough melting temperature to withstand further manufacturing steps for incorporating the fabric into the closed cell foam composite, including processing temperatures above 200° C.

The fabric is coated to a suitable thickness with a foamed or unfoamed formulation. In one preferred embodiment, the thickness is in the range of about ⅛ to about 3/16 inches, although other thicknesses may be suitable for a particular application. A suitable coating formulation may include a resin dispersion in a diester plasticizer to produce a foamed or unfoamed coating, having a weight per unit area in the range of about 10 to about 50 ounces per square yard, and preferably, in the range of about 16 to about 20 ounces per square yard. Suitable diester plasticizers include dioctyl phthalate, or other plasticizers, as are known in the art. Considerations in choosing a particular diester plasticizer for the formulation may include volatility, permanence, hot melt properties, availability and cost.

Resin dispersions which are suitable for the formulation include vinyl resin dispersions or polyvinyl chloride (PVC) resin dispersions, although other resins as known in the art may also be suitable. By way of example only, Kaneka PVC 72 (available from Kaneka America Corporation of New York, N.Y.) is a suitable resin for use in the present invention. The molecular weight of the resin is a key consideration in its selection, as the molecular weight helps to determine the cell structure having sufficiently closed cells. For example, a relatively low molecular weight polyvinyl chloride and diester plasticizer combination would produce an appropriate closed cell foam, whereas a relatively high molecular weight combination would produce an open cell structure which is undesirable for the present invention.

A “K value” is an international measure used to characterize the degree of polymerization or the molecular weight of a polymer resin that may be computed from dilute solution viscosity measurements. In accordance with the present invention, suitable molecular weights for the PVC resin dispersion include K values in the range of about 55 to 75, although other molecular weights may be appropriate for particular applications. For example, the use of relatively low molecular weight resins having K values below 55 would provide a formulation which would be in a soft “hot melt” state as the fabric and coating exit a fusion oven. The hot melt condition of the formulation can provide a surface temperature of about 340° F. which may be suitable for adhering films, mats, or other coating layers to the exterior surfaces of the closed cell foam composite without additional glues or adhesives.

Blowing agents such as gas release agents can also be included in the coating formulation in order to produce an appropriate closed cell structure of the coating. Suitable gas release agents include nitrogen producing azo di carbonamide. Other blowing agents such as ortho bis benzenesulfonyl hydrazide and toluene sulfonyl hydrazide and semicarbazides are also appropriate.

The incorporation of fillers in the formulation at various levels, such as pre-formed cells of ceramic, plastic, or micro encapsulated expandable fillers, are also suitable to affect the coefficient of friction and the sound deadening characteristics of the cushion. For example, the absence of fillers results in a cushion having a relatively high coefficient of friction. Combinations of calcium carbonate and heavy low oil absorption barium sulfates increase the sound deadening characteristics of the foam. In addition, with filler additives, the foam and unfoamed density of the coating can range anywhere from about 10 pounds per cubic foot to about 150 pounds per cubic foot.

Other additives may be included in the formulation as well. For example, fire retardant and anti-microbial agents may be added. In addition, dyes and colorants may be added to the foam formulation to create a finished composite having decorative colors including translucents, bright opaques and soft pastels. Further, colors and designs may be printed onto the surface of the composite as it exits the oven, as discussed below.

Examples of suitable formulations for the present invention are provided as follows:

| EXAMPLE A | PARTS |
|---|---|
| Vinyl resin dispersion | 100 |
| (average K value of 55 to 75) | |
| Diester plasticizer (dioctyle | 50-150 |
| phthalate) | |
| Gas release agent | 0-10 |
| (nitrogen producing azo | |
| di carbonamide) | |
| Zinc octoate gas release promoter | 1 |
| Calcium carbonate inert filler | 0-400 |
| Fire retardant (antimony oxide) | 2-5 |
| Color | 1 |

| EXAMPLE B | PARTS |
|---|---|
| Polyvinyl chloride resin dispersion | 100 |
| Diester plasticizer (dioctyle phthalate) | 100 |
| Gas release agent | 4-5 |
| (nitrogen producing azo di carbonamide) | |
| Zinc octoate gas release promoter | 1 |
| Calcium carbonate inert filler | 50 |
| Fire retardant (antimony oxide) | 2-5 |
| Anti-microbial (zinc perithione) | 0.5 |
| Dye (color) | 2 |

For applications requiring fire retardant properties, 2 to 5 parts of antimony oxide will produce average critical radiant flux values above 1 watt/square centimeter when tested according to ASTM E648-99 (class 1 rating).

One method of manufacturing the cushion comprises the use of a tenter frame oven. A fabric susbstrate is tentered at its edges to a conveyor belt or other moving support structure. The coating is metered onto the fabric as it moves with the conveyor belt by spray nozzles which coat the fabric with a predetermined amount of coating. Alternatively, the fabric can move across a drum which is rotating in a bath of the formulation to coat the fabric. A knife or other blade which is positioned at a predetermined distance from the moving support structure removes excess coating from the fabric leaving a desired amount or thickness thereon. As discussed hereinabove, suitable coating thicknesses may, in one preferred embodiment, range from about ⅛ to about 3/16 inches, but other thicknesses may be useful in some applications. Other methods known to one skilled in the art are suitable for metering the coating onto the fabric. For example, the cushion can be formed using standard casting processes on stainless steel or teflon coated fiberglass carriers. This particular technique imparts a texture on the bottom surface of the foam composite which is characterized by the texture of the belt. Following the application of a polymer resin, the coated fabric composite then moves into a fusion oven set at the appropriate temperature to expand and cure the closed cell foam material.

Of course, the manufacturing process may be adjusted to achieve particular physical characteristics in the finished foam composite sheet. By way of example only, to produce the lowest density and the finest cell structure in a closed cell foam, the PVC saturated fabric should be allowed to expand freely in the vertical plane, unrestricted in any way, by heating the PVC saturated fabric to a temperature range of about 360 to about 390° F. In one preferred embodiment, the upper and lower surfaces of the composite are subjected to hot air circulating at about 300 to 1000 feet per minute throughout the oven. This may be accomplished by using a tenter oven in which the saturated fabric substrate is stretched across a carrier chain fitted with pins, clips, clamps or other fasteners to hold the fabric at its edges and to maintain the fabric in a stretched condition. Although not as preferred, the PVC saturated fabric may also be carried through the curing oven on a non-porous smooth or textured belt with only the top surface of the PVC saturated fabric exposed to the circulating hot air.

Using a tenter oven manufacturing technique, the PVC saturated fabric is immediately subjected to high heat and the necessary residence time at this heat is essentially a function of the heat conductivity of the PVC formulation. For PVC coatings of 5 to 20 ounces per square yard, this is accomplished in 1 to 5 minutes at the specified air velocities. It is notable that higher air velocities will tend to strip plasticizers from the surface and burn the surface before the heat conductivity of the formulation permits the center of the matrix to reach gas emitting levels of about 360 to 390° F.

Additionally, infra red heat sources at intensities of about 10 to 20 watts per square inch may be used to facilitate curing of the foam in specific areas for thicker coating in excess of 10 ounces per square yard. For coatings thinner than 10 ounces per square yard, infra red heat sources may be used partially or totally cure the PVC foam with residence times of about 10 to 30 seconds for complete expansion and fusion of the PVC material.

In another embodiment, a latex or water-based rubber emulsion may be used to form a fabric reinforced closed cell foam composite with varying degrees of density of the polymer coating. For a latex foam mixture containing low-boiling, liquid-filled plastic microspheres, it is possible to expand these microspheres to as much as 80 times their original size by applying heat to volatize the liquid that is trapped within the microsphere. By way of example only, several suitable microspheres include Expancel 053WU40 (available from Boud Minerals and Polymers of Kent, United Kingdom) and Micropearls F30 or F50 (available form Pierce & Stevens Corp. of Buffalo, N.Y.).

One example of a formulation for a closed cell latex foam would be:

| Styrene butadiene (SBR) latex | 70 parts dry |
|---|---|
| Natural rubber latex | 30 |
| Zinc oxide | 10 |
| Sulfur | 5 |
| Ethyl zimate | 2 |
| Expancel 053WU40 | 5 |

Those skilled in the art may vary the dry latex proportions and accelerators to change the properties of this latex foam formulation to meet specific needs. The amount and grade of expandable microspheres may also be varied to provide a density range of about 6 pounds per cubic foot all the way up to about 80 pounds per cubic foot. Similar latex formulations can be used to substitute components and go from an SBR/natural rubber latex to an acrylic latex as well as neoprene, nitrile latex, vinyl and vinyladene latexes, vinyl acetate latexes, urethane latexes and any combination of these.

Latex foam composites may be manufactured in much the same way as PVC foam composites except that the temperatures and times in the curing oven are very different. Latex foam coating formulations typically contain about 30% to 60% water. This water must be removed prior to raising the temperature of the latex above the boiling point of water. This may be done at temperatures between about 120 and 200° F. for a period of about 5 to 20 minutes depending upon the thickness of the film and the water content of the latex. The product is then cured and expanded at the temperature recommended by the supplier of the microsperes.

Note that the method of manufacturing the cushion may also produce varying surface characteristics in the cushion composite, for example, relatively smooth or textured surfaces. A smooth surface is provided when the composite is cast on a smooth belt or smooth moving structure which supports the fabric during the manufacturing process. A textured top or bottom surface of the composite can be provided by varying the amount of coating distributed over the hills and valleys of the interstices of the fabric and subsequently increasing the amount of volume variations as the foam cells are formed. Further, the surfaces of the composite can be embossed with textures, imprints, designs and other surface modifications for coordination with the surroundings where the cushion is placed. The surface modifications can be applied to either the top or the bottom surfaces of the fabric and coating composite as it exits the fusion oven by the use of a teflon coated embossing roll, as known in the art.

The closed cell characteristic of the composite provides a non-porous exterior and allows the surfaces to be relatively easy to clean. In addition, the closed cell foam cushion is waterproof and will not absorb fluids. Further, the coefficient of friction for the cushion surfaces may be adjusted to be relatively high, for example, above 1, by controlling the type and amount of filler additives in the formulation to impart non-slip features to the cushion.

The closed cell foam composite also deadens sounds and absorbs vibrational energy. For example, certain foam formulations can produce cushions that are capable of absorbing over 90% of the momentum of objects coming in contact with the composite. Certain composites may also be used to deaden relatively high frequency noises, for example, noises from glass having frequencies above 1000 hertz. Further, the cushion composite is dimensionally stable, thus the corners tend to remain flat when placed on a smooth surface and do not curl over time. In dry (i.e., non-adhesive) place and stick applications, the composite cushion can be positioned where desired on a surface and within a relatively short period of time, for example, about one hour, the composite will remain in place until forcibly removed.

The closed cell foam composite has a wide variety of uses. It is suitable for use as an underlayment in flooring systems, functioning as a moisture barrier, a sound deadener and an energy absorber. In one embodiment the underlayment may also be adhered to a layer of felt material. This felt material will serve to further deaden sounds and dampen vibrations in the decorative floor treatment that it placed under. During installation, an underlayment is generally placed over a subfloor which is constructed of concrete, wood or other suitable materials. A decorative floor treatment such as wood, simulated wood, laminates, ceramic tiles, synthetic and nature stone slabs and mosaics, is then placed over the underlayment. Additional decorative floor treatments in which performance could be enhanced with the cushion underlayment of the present invention include vinyl sheet goods, vinyl tiles, carpet tiles, and carpet roll goods.

The underlayment can be adhered to the decorative floor treatment to create a laminate which is applied over the subfloor. Alternatively, the underlayment can be a separate component applied to the subfloor followed with the application of the decorative floor treatment. The high strength to weight ratio of the fabric reinforced closed cell foam composite enhances the strength of the joints of certain decorative floor treatment. The reinforced foam composite should exhibit sufficient strength to resist tearing at nail sites or under the stress of hammering floor boards in place at installation. Underlayments having tensile strengths below about 200 psi or tear strengths below about 2 pounds will often fail. In one preferred embodiment of the present invention, described hereinabove in Example B, the closed cell foam composite exhibited a tensile strength of 554 psi and a tear strength of 4.1 pounds. It has also been noted that highly-filled materials containing relatively large amounts of calcium carbonate or clay may tend to crumb-up or crumble after repeated flexing created by expansion and contraction as well as repeated stress.

In the application of click type joints of decorative floor components, the underlayment provides strength under and adjacent to the joints to enhance the mechanical bond of the joint edges. In addition, a seal is formed between the underpayment and the adjacent bottom surface of the joints which helps to help prevent the lower edges of the joints from separating under flex. The seal also helps to prevent moisture or liquids from migrating down through the joint of the decorative floor treatment or up from the subfloor. Further, the reinforcing fabric of the underlayment allows for easy removal and replacement of decorative floor treatments which may be adhered to the underlayment. When properly adhered to a decorative floor treatment, the underlayment of the present invention stabilizes the flooring system and forms a floating floor system with the decorative floor treatment which may move together, as one unit, relative to the subfloor.

An adhesive which is compatible with the underlayment, for example, a slow drying ethylene vinyl acetate (EVA) adhesive, can be applied to the top surface of the underlayment for adherence to the underside of the decorative floor treatment. The adhesive can be applied by any suitable method for applying controlled amounts of product in defined areas. Aerosol spraying, airless spraying, pressure spraying, roller application, including napped or textured roller, brush application and notched blade application are suitable methods for applying the adhesive. The adhesive can be applied along the areas of the underlayment which would correspond to the joints of a decorative floor treatment. While application rates of the adhesive can range anywhere from about 300 to 500 square feet per gallon, the amount of adhesive required is dependent on the method of application and the amount of area to be covered. For example, if a narrow band of adhesive were applied by means of a roller application on either side of the joint, then a relatively heavier coating would be preferable. In addition, a relatively heavier coat of adhesive would provide sufficient time for positioning the joint before the adhesive dries.

The adhesive can also be applied to the underside of the decorative floor treatment. The joint edges of the decorative floor treatment can be mated by applying a bead of adhesive along the undersides of the joints to seal their underside edges. A sealed underside joint edge could minimize the flow of fluids through the joint down from the decorative flooring or up from the subfloor or underlayment. The strength of the joint is enhanced by the application of the adhesive into a gap which is milled into the mating surface profiles on the underside of the joints to provide an intimate top edge surface to surface contact for adjacent decorative floor treatment joints. An adhesive having a modulus of, for example, 200% elongation below 500 pounds per square inch would allow the gap to compress enough to maintain joint flexibility. With 100% recovery of elongation or compression after stress, the joint would return to normal after deformation.

The cushion composite of the present invention is also suitable for use as shelf, drawer, bath or shower liners, place mats, table cloths, furniture surface covering and other applications requiring a cushion covering. As detailed above, suitable cushions would include a composite formed from a polyester tricot of 1.65 ounces per square yard which has been impregnated and coated with about 16 to 20 ounces per square yard of a closed cell vinyl formulation. The high strength to weight ratio of the cushion, its hydrophobic, sound deadening, energy absorption and non-slip characteristics, and its dimensional stability are suitable for such uses. The decorative nature of the cushion either by the addition of print to the cushion surface or of dye to the foam formulation, is particularly suitable for applications where design coordination with the surroundings is desired. Cushions for use as bath and shower liners are useful for their non slip features and cushioning effect. Decorative bath and shower liners are also desirable to enhance and coordinate with the colors and designs in the room in which they are placed.

While a number of preferred embodiments of the invention has been shown and described herein, modifications thereof may be made by one skilled in the art without departing from the spirit and the teachings of the invention. The embodiments described herein are exemplary only, and are not intended to be limiting. Many variations, combinations, and modifications of the invention disclosed herein are possible and are within the scope of the invention. Accordingly, the scope of protection is not limited by the description set out above, but is defined by the claims which follow, that scope including all equivalence of the subject matter of the claims.

What is claimed is:

1. A reinforced foam composite comprising:
a closed cell foam sheet;
a fabric having open interstices between fibers; and
wherein said fabric is completely embedded within the closed cell foam sheet.

2. The reinforced foam composite according to claim 1 wherein the closed cell foam sheet is formed of an SBR/natural rubber blend.

3. The reinforced foam composite according to claim I wherein the closed cell foam sheet is formed of PVC.

4. The reinforced foam composite according to claim 1 wherein the closed cell foam sheet is formed of polyurethane.

5. The reinforced foam composite according to claim 1 wherein the fabric is a non-woven.

6. A method of making a reinforced foam composite comprising the steps of:
preselecting a fabric having open interstices between fibers;
coating the upper and lower surfaces of the fabric with a foam resin composition; and
applying heat to the coated fabric to expand and cure the foam resin composition.

7. The method according to claim 6 further comprising the step of stretching the fabric in a transverse direction prior to coating with a foam resin composition.

8. The method according to claim 7 wherein the fabric is stretched on a tenter.

9. The method according to claim 6 wherein the step of applying heat further comprises circulating heated air over the coated fabric.

10. The method according to claim 9 wherein the foam resin comprises PVC and the heated air has a temperature of about 360 to about 390° F.

11. The method according to claim 9 wherein the foam resin comprises latex and the heated air has a temperature of about 120 to about 200° F.

12. The method according to claim 9 wherein the heated air is circulated at about 300 to about 1000 feet per minute across the upper and lower surfaces of the coated fabric.

13. The method according to claim 6 wherein the step of applying heat further comprises exposing the coated fabric to an infrared heat source having a intensities of about 10 to about 20 watts per square inch.

14. The method according to claim 13 wherein coated fabric is exposed to the infrared heat source for about 10 to about 30 seconds.

15. The method according to claim 6 further comprising the step of adhering a layer of felt to the foam composite.

16. A reinforced foam composite manufactured according to the method of claim 6.

17. A method of making a reinforced foam composite comprising the steps of:
preselecting a fabric having open interstices between fibers;
stretching the fabric transversely on a tenter;
coating the upper and lower surfaces of the fabric with a foam resin composition; and
circulating heated air at about 300 to about 1000 feet per second across the upper and lower surfaces of the coated fabric;

18. The method according to claim 17 wherein the foam resin comprises PVC and the heated air has a temperature of about 360 to about 390° F.

19. The method according to claim 17 wherein the foam resin comprises latex and the heated air has a temperature of about 120 to about 200° F.

20. The method according to claim 19 wherein the foam resin comprises latex containing liquid filled microspheres.

21. A reinforced foam composite manufactured according to the method of claim 17.
